(19) United States
(12) Patent Application Publication
(10) Pub. No.: US 2019/0087839 A1
(43) Pub. Date: Mar. 21, 2019

(54) Product Development Methods for Non-Verbalizing Consumers

(71) Applicant: Big Heart Pet, Inc., Orrville, OH (US)

(72) Inventors: Jill Villarreal, Daly City, CA (US); Philip A. Gable, Tuscaloosa, AL (US)

(73) Assignee: Big Heart Pet, Inc., Orrville, OH (US)

(21) Appl. No.: 16/192,085

(22) Filed: Nov. 15, 2018

Related U.S. Application Data
(63) Continuation of application No. 14/516,966, filed on Oct. 17, 2014.

(51) Int. Cl. G06Q 30/02

(52) U.S. Cl. CPC G06Q 30/0203; G06Q 30/0201

(57) ABSTRACT

The disclosure relates to methods for assessing the emotional response of non-verbalizing consumers to products and product alternatives. The disclosure further relates to methods for assessing the emotional responses of humans to viewing interactions between non-verbalizing consumers and products or product alternatives. These assessments, separately or together, can guide the design and content of products and materials used to inform potential human purchasers about products intended for non-verbalizing consumers—particularly when the viewing-humans stand in a custodial or ownership relationship to the non-verbalizing consumers.

### CROSS REFERENCE TO RELATED APPLICATION

This application claims the priority and benefit of U.S. Utility application Ser. No. 14/516,966, titled “Product Development Methods for Non-Verbalizing Consumers,” filed on Oct. 17, 2014, which is herein incorporated by reference.

### BACKGROUND OF THE DISCLOSURE

This disclosure relates generally to the field of product design and development.

A wide variety of methods can be used to assess the preferences of consumers and purchasers who are able to express their opinions and their reactions to products and product variants. For example, verbal or written surveys can be used to collect impressions and opinions of actual or potential consumers or purchasers of a product. Such impressions and opinions can be based on memories of past purchases or consumption of the product, on opinions expressed at or near the time of sale or consumption, on verbal or written descriptions of planned or contemplated variations in a product, on samples of products or product variants that are offered to subjects, or on other materials or information.

Consumers unable to verbally describe their opinions and preferences (whether orally or in written form) present difficulties to designers and developers of products. Because these consumers do not verbally express them, their opinions and preferences must be inferred from their behavior. Such inferences often lack objectivity and can be difficult to accurately make, even by an observer/reporter attempting to objectively study the behavior of other animals. Apart from subjectivity implicit in interpreting the behavior of another animal, such observer/reporters can also exhibit subjectivity in attempts to conform with actual or perceived conditions of the study.

Even facially objective studies can obscure the opinions and preferences of non-verbalizing consumers. For example, a test of animal feeding preference commonly used in the past is the “two bowl” test (see FIG. 1), in which an animal is presented with two portions of different foods (e.g., simultaneously) and the animals preference is scored as the food which the animal consumes in greater quantity. However, food consumption by an animal can be influenced by a number of factors in addition to preference, such as bowl position, lighting, and presence of humans, so the outcome of the “two bowl” test is not necessarily determinative of animal preference. Similarly, observations of animal behavior before, during, or after presentation with a food or treat (see FIG. 2) has been used as a measure of animal enjoyment (“liking”) of pet care products. However, many factors can influence animal behavior, and the influence of pet care products on behavior can be difficult to isolate.

In any event, measures of animal “liking” of pet care products that have been used in the past do not necessarily represent the information that is the most relevant to what a designer or developer of such products seeks to assess. Because non-verbalizing consumers, whether they be cats, dogs, or human infants, do not purchase products for their own consumption, a designer or developer of such products does not necessarily design and develop a product based solely on the opinions and preferences of the consumer, but rather designs and develops products to appeal to the purchaser of the product. The purchaser is typically a parent of the non-verbalizing consumer (i.e., a genealogical parent, another care-giver, or a custodian for a human consumer or an owner of, care-giver for, or custodian of a non-human consumer, such as a cat, dog, reptile, fish, horse, cow, pig, sheep, or goat).

A need exists for improved methods of designing and developing products to appeal to purchaser's perception of the opinions and preferences of non-verbalizing product consumers. The subject matter disclosed herein satisfies this need.

### BRIEF SUMMARY OF THE DISCLOSURE

The subject matter disclosed herein relates to a method of assessing purchaser preference for embodiments of a product intended for consumption by non-verbalizing consumers. The method includes the step of separately assessing spontaneous emotional responses exhibited by each of a plurality of human observers. Those responses are assessed as each observer observes provision (directly or indirectly, live or recorded) of at least a first embodiment of a product and a second embodiment of a product to one or more animals of the same species as the non-verbalizing consumers. The method also includes comparing i) the responses of the observers of provision of the first embodiment to the animals and ii) the responses of the observers of provision of the second embodiment to the animals in order to determine a preference of the observers. The observers' preference can be used as a surrogate for the preference of potential purchasers of the product. The responses of the observers can be considered individually, or the assessments of multiple observers can be integrated. In another embodiment of the subject matter described herein, a subjective assessment of each animal's response to each embodiment is also recorded for each observer.

Spontaneous emotional responses which can be assessed in these methods include one or more of electroencephalography (EEG) responses, electromyography (EMG) responses, facial movements, heart rate variation, skin conductance, functional magnetic resonance imaging (fMRI), electroencephalography (EEG), monitoring of heart rate, monitoring of heart rate variability, monitoring of ear temperature differences, monitoring of ear temperature changes, monitoring of pupil dilation, monitoring of saliva hormone levels, monitoring of saliva neurotransmitter levels, monitoring of blood hormone levels, and monitoring of blood neurotransmitter levels.

In one embodiment, the observers are selected to be parents of an individual of the same species as the non-verbalizing consumers or a former parent of such an individual. The consumers consumers can be animals of a species kept as pets by humans (e.g., cats or dogs). The consumers consumers can, alternatively, be animals of a species kept as working animals by humans. The consumers can also be non-verbalizing humans, such as human infants (observers who have parented a child can be preferred observers of infants).

The subject matter disclosed herein also relates to a method of designing a product for non-verbalizing consumers. The method involves producing first and second embodiments of the product. The embodiments are separately provided to individual consumers, and such provision is observed by human observers. The method includes separately recording spontaneous physiological responses in each of the human observers as each observer observes provision of the first and second embodiments of the products to the consumers. The responses of the observers of provision of the first embodiment to the consumers are compared with the responses of the observers of provision of the first embodiment to the consumers. This comparison yields a preference of the observers as a surrogate for the preference of the consumers. The embodiment preferred by the observers can be incorporated into the product.

The subject matter described herein further relates to a method of designing a product for non-verbalizing consumers. This method includes separately assessing spontaneous emotional responses exhibited by each of a plurality of human observers as each observer observes provision of at least a first embodiment of the product and a second embodiment of the product to at least one animal of the same species as the non-verbalizing consumers. The responses of the observers to provision of the first embodiment are compared with the responses of the observers to provision of the second embodiment to the consumers. This comparison determines the preference of the observers. The embodiment preferred by the observers can be incorporated into the design of the product.

This disclosure further describes a method of assessing perceived preference of non-verbalizing consumers for product embodiments. The method includes separately assessing spontaneous emotional responses exhibited by each of a plurality of human observers as each observer observes provision of at least a first embodiment of the product and a second embodiment of the product to at least one animal of the same species as the non-verbalizing consumers. The responses of the observers to provision of the first embodiment are compared with the responses of the observers to provision of the second embodiment to the consumers in order to determine a preference of the observers.

### BRIEF SUMMARY OF THE SEVERAL VIEWS OF THE DRAWINGS

FIG. 1 is a diagram which illustrates a previously-known method (“the two-bowl method”) of assessing an animal's preference for alternatives of a product. In this diagram, the product alternatives are illustrated as bowls of food labeled “A” and “B.” In the two-bowl method, a non-verbalizing consumer (here, illustrated as a cat) is presented with a bowl of each of alternatives A and B, permitted to interact with the bowls for a period of time, and the amount of each of alternatives A and B consumed by the cat is determined (e.g., by weighing). This method yields information about the quantities of foods A and B (Q_{A} and Q_{B}) consumed by the cat.

FIG. 2 is a diagram which illustrates another previously-known method of assessing an animal's preference for alternatives of a product. In this diagram, the product alternatives are illustrated as bowls of food labeled “A” and “B.” In this method, a human observer watches a non-verbalizing consumer (here, illustrated as a cat) interact with and, optionally, consume the product alternatives. The human observer thereafter provides verbal or written comments (C_{A} and C_{B}) pertaining to the observer's subjective reactions to the consumer-product interaction.

FIG. 3 is a diagram which illustrates an embodiment of the method described herein. In this method, a human observer visually observes (dotted line) a non-verbalizing consumer (here, illustrated as a cat) interacting with and, optionally, consuming a product alternative (here, illustrated as a bowl of food labeled “A”). The observer can observe a recording of the interaction or a live interaction (signified by a box surrounding the cat and product). A quantifiable physiological response of the observer (here, illustrated by a meter attached via a pair of leads to a cap worn by the observer) is assessed, and that physiological response is used to assess the emotional response (ER_{A}) of the observer (and to estimate the emotional response of the non-verbalizing consumer) to the consumer's interaction with the product alternative. The observer is preferably a parent (as the term is used herein) of the consumer.

FIG. 4 is a diagram which illustrates another embodiment of the method described herein. In this method, a human observer visually observes (dotted line) a non-verbalizing consumer (here, illustrated as a cat) interacting with and, optionally, consuming a product alternative (here, illustrated as a bowl of food labeled “A”) in the presence of a second human who presents the product alternative to the consumer. The observer can observe a recording of the interaction or a live interaction. A quantifiable physiological response of the observer (here, illustrated by a meter attached via a pair of leads to a cap worn by the observer) is assessed, and that physiological response is used to assess the emotional response (ER_{A}) of the observer (and to estimate the emotional response of the non-verbalizing consumer) to the consumer's interaction with the product alternative and the other human. The observer is preferably a parent (as the term is used herein) of the consumer.

FIG. 5 is a diagram which is a variant of FIG. 3, highlighting that the physiological responses can be assessed for multiple human observers to viewing the same consumer-product interaction (i.e., either live or via a recording viewed by the observers at the same time or at different times). Those physiological responses can be correlated with the emotional responses of the observers, for example to assess the likelihood that viewing the interaction will motivate humans similar to the observers (e.g., humans who are also cat parents) to purchase the product alternative.

FIG. 6 is a diagram which is also a variant of FIG. 3. FIG. 6 illustrates that the physiological responses and/or the emotional responses of a single observer (or different observers or groups of observers, as in FIG. 5) can be assessed for different product alternatives (here, illustrated as bowls of food labeled “A” and “B”), and that those physiological and/or emotional responses can be compared for the two alternatives.

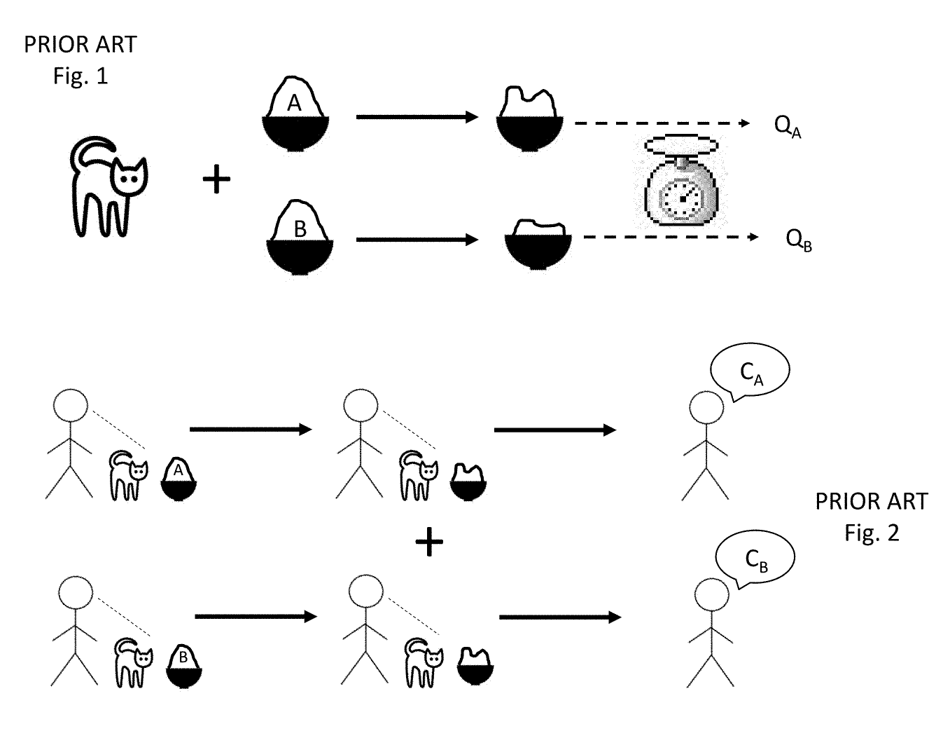

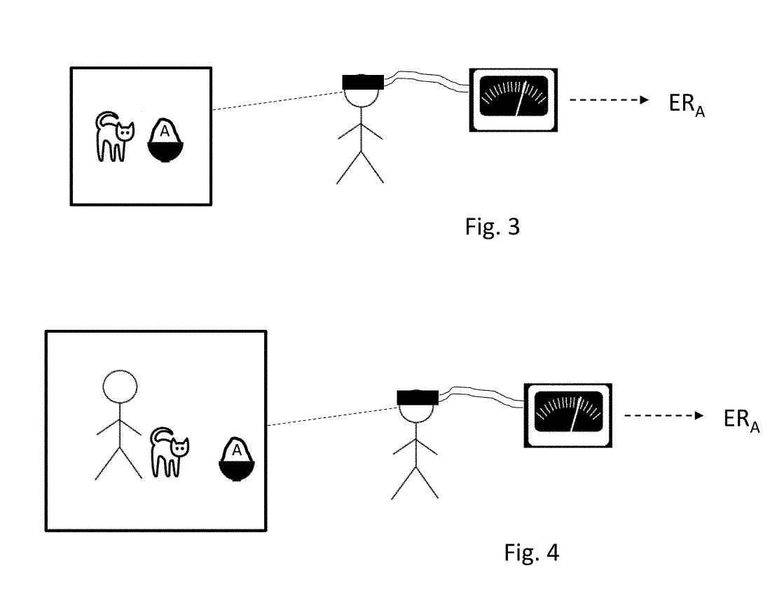

### DETAILED DESCRIPTION

The disclosure relates to methods for determining emotional responses exhibited by consumers which are unable or unwilling to describe their opinions, desires, or preferences in a written or spoken language understandable by humans (i.e., “non-verbalizing consumers”). Designing and developing a product to appeal to a purchaser's perception of the desires, opinions, and preferences of a consumer cared for by or within the custody of the purchaser can improve the appeal of the product to such purchasers and their ultimate satisfaction with the product.

The methods include, for example, methods of assessing the emotional responses of domestic animals when presented with pet care products (e.g., foods or treats), by directly measuring the responses of the animals, by assessing the emotional responses of humans who observe (live or by way of a recording) presentation of the products to the domestic animals, or by a combination of these methods. The methods also include, by way of further example, methods of assessing the emotional responses of non-verbalizing humans (e.g., infants).

The methods involve assessment—in two types of subjects—of objectively quantifiable physiological responses. One type of subject is a non-verbalizing consumer, for which physiological responses indicate the non-verbalizing consumer's emotional response to a product or a product variant. The other type of subject is a human who observes a non-verbalizing consumer's interaction with a product or a product variant. The physiological responses of these humans can be informative in their own right, for example, to the extent that they indicate the emotional response of the humans to their perception of the consumer's interaction, particularly when the human observers are representative of purchasers of the product. The physiological responses of these humans can also be used as an indication of (or surrogate for) the non-verbalized emotional response of observed consumers—especially when the observing humans are familiar with animals of the same type (e.g., dogs, cats, or human infants) as the non-verbalizing consumers, such as when the observers are parents of such an animal (whether the same animal being observed or an animal of the same species).

Parents of a non-verbalizing consumer often and presumably desire to purchase products which will elicit favorable emotional responses (e.g., happiness, contentment, playfulness, and affection for the parent) in the consumer. However, the inability of the non-verbalizing consumers to express opinions, desires, and preferences through language require that the purchaser instead rely on the purchaser's perception of the consumer's emotional reaction(s) to the product. A designer or developer of a product intended for consumption by a non-verbalizing consumer needs to consider how the purchaser will perceive the consumer's response to the product when deciding which features or ingredients to include in a product and to consider which depictions of product-inspired behaviors will convey to purchasers that purchase of the product will inspire enjoyment in one or both of the consumer and the purchaser. Thus, it is the purchaser's perception of a non-verbalizing consumer's emotional response to a product (rather than, necessarily, the consumer's response itself) that is critical to the decision whether or not to purchase the product.

As used herein, the term “parent” refers expansively to individual humans who are a genealogical parent of a non-verbalizing consumer, a care-giver for a non-verbalizing consumer, or a custodian of a non-verbalizing consumer. A parent may, for example be, a biological parent of a non-verbalizing human consumer (such as the biological parent of an infant) or an owner or custodian of a non-human consumer, such as a cat, dog, reptile, fish, horse, cow, pig, sheep, or goat. Significantly, such a parent has acquired sufficient familiarity with the behavior of the non-verbalizing consumer that the parent observes or with the behavior of another animal of the same species as the non-verbalizing consumer (e.g., the parent owns and cares for a cat, and observes the behavior of a different cat than the one owned by the parent).

The methods described herein are directed to methods of generating information that can be used by product designers and developers to influence the perception by a purchaser of the product of how much the product will be enjoyed by a non-verbalizing consumer for which the purchaser is considering a purchase of the product. These methods are described in greater detail below.

Enjoyment of a product manifests itself in several observable physiological phenomena. Such phenomena can be exhibited by an animal interacting with the product. Those phenomena can also be exhibited by a human observer who observes an animal interacting with a product. Phenomena exhibited by human observers can be particularly relevant when those observers are (past or current) parents of an animal of the same species. By way of examples, enjoyment by cats of a food product can be assessed by observing the behavior of individual cats (or groups of cats) when presented with the food product, such as whether a cat appears interested in the food, whether the cat rubs against a container containing the food product or a human presenting the food product, or the cat's reactions upon consuming the food product. Further by way of example, enjoyment of dogs of a toy or treat product can be assessed by observing the behavior of individual dogs (or groups of dogs) when presented with the product, such as whether a dog acts excited, wags its tail, focuses intently on the product, or barks in reaction to the product or its presentation to its view.

Enjoyment, and non-enjoyment, can be detected by assessing a variety of methods and devices which are capable of detecting or measuring those responses. Examples of physiological phenomena that can be assessed include electroencephalography (EEG) responses, electromyography (EMG) responses, facial movements, heart rate, heart rate variation, skin conductance, changes detectable by functional magnetic resonance imaging (fMRI), ear temperature differences, ear temperature changes, pupil dilation, and hormone and neurotransmitter levels (e.g., in blood or saliva). Methods of assessing the occurrence and magnitude of these phenomena are well known and are described in the art. These phenomena can be measured in one or both of animals interacting with a product and humans observing such animal-product interactions.

The precise method(s) used to assess relevant physiological phenomena are not critical, so long as assessments of the phenomena can be obtained. It is understood that subject compliance issues associated with some of these techniques for assessing physiological phenomena can limit the usefulness of the techniques for some types of assessments. By way of example, assessment of fMRI data in an observer requires that the observer lie still for substantial periods of time. fMRI assessments would, therefore and as an example, be an inappropriate method of assessing physiological phenomena in observers watching consumer-product interactions occurring over a wide field of view, such as dogs chasing thrown toys in a large field, which would require observers to move their heads.

An objective of assessing observers' physiological responses to interactions of non-verbalizing consumers with a product is to assess whether those observers exhibit a positive or negative emotional response to the interaction(s) they view. Especially when the observers share characteristics of anticipated purchasers of the product (e.g., the observers, like anticipated purchasers of a cat food, are cat parents), positive emotional responses of observers to a certain consumer behavior can be predictive that anticipated purchasers will likewise exhibit positive emotional responses (including motivation to purchase the product) if they view the same or similar behavior. Similarly, consumer-product interactions which induce negative emotional responses in observers can be expected to induce negative emotional responses (including inhibition for purchasing the product) in similar potential purchasers.

The range of physiological responses that are considered ‘positive’ emotional responses by observers varies with the nature of the physiological response assessed and the methods used to assess it. Corresponding ranges and responses are known in the art, including in references cited in this disclosure. The following are provided as examples of positive and negative responses that are known to correlate with particular techniques for assessing physiological indicators of emotional response.

1) In observers whose physiological responses are assessed using electroencephalography (ECG), positive emotional responses to observation of a consumer-product interaction are indicated, for example, by increases in approach motion, as manifested in greater left frontal cortical activity. Positive emotional responses in such observers are also indicated, for example, by increases in action preparation, as manifested in beta suppression over the motor cortex. Negative emotional responses to observation of a consumer-product interaction in these observers are indicated, for example by decreases in approach motion (e.g., manifested as a decrease in left frontal cortical activity) and/or by decreases in action preparation (e.g., manifested as a decrease in beta suppression over the motor cortex).

2) In observers whose physiological responses are assessed using electromyography (EMG), positive emotional responses to observation of a consumer-product interaction are indicated, for example, by increases in zygomaticus major activity, and negative responses are indicated, for example, by increases in corrugator supercilii activity.

3) In observers whose physiological responses are assessed by observing mirror neuron activity, positive emotional responses to observation of a consumer-product interaction are indicated, for example, by increases in mu suppression (i.e., decreases in mirror neuron activity over the motor cortex), and negative responses are indicated by decreases in such suppression activity.

4) In observers whose physiological responses are assessed by observing heart rate variability, a decrease in variability is seen in observers who exhibit a negative emotional response to observation of a consumer-product interaction.

5) In observers whose physiological responses are assessed by observing ear temperature differences, increased ear temperature difference is seen in observers who exhibit a negative emotional response to observation of a consumer-product interaction.

6) In observers whose physiological responses are assessed by observing cortical levels (e.g., in blood or saliva), increased cortical levels are correlated with observers who exhibit a negative emotional response to observation of a consumer-product interaction.

7) In observers whose physiological responses are assessed by observing oxytocin levels (e.g., in blood or saliva), increased oxytocin levels are correlated with observers who exhibit a positive emotional response to observation of a consumer-product interaction.

8) In observers whose physiological responses are assessed by observing catecholamine levels (e.g., in blood or saliva), increased catecholamine levels are correlated with observers who exhibit a positive emotional response to observation of a consumer-product interaction.

9) In observers whose physiological responses are assessed by observing adrenocorticotropic hormone (ACTH) levels (e.g., in blood or saliva), increased ACTH levels are correlated with observers who exhibit a positive emotional response to observation of a consumer-product interaction.

10) In observers whose physiological responses are assessed by observing prolactin levels (e.g., in blood or saliva), increased prolactin levels are correlated with observers who exhibit a positive emotional response to observation of a consumer-product interaction.

Observers who exhibit positive emotional responses to interactions between non-verbalizing consumers and a product exhibit enhanced motivation and intent to purchase the product. This observation indicates that potential purchasers of the product who observe similar interactions (e.g., in television or print media) will be similarly motivated to purchase the product in response to positive emotional responses. The techniques described herein therefore represent an objective method for selecting substantive content (e.g., images or recordings of consumer-product interactions) for depiction to purchasers who are considering whether to acquire the product for a consumer.

By way of examples, the behaviors described in the examples herein as “rub,” “lead,” and “standing” induced physiological responses which could be correlated with positive emotional responses (action preparation and mirror neuron activity) in observers who observed such behaviors in cats interacting with a product. In addition, the “lead” and “standing” behaviors also induced an additional positive emotional response (approach motion) in those observers, indicating that these three behaviors can, if shown to or seen by potential purchasers, be expected to inducing purchasing behavior.

A primary goal of product designers is to include in a product design features and/or ingredients which induce enjoyment of the product by a consumer. Induction of phenomena which are indicative of enjoyment of a product by a consumer is thus an indication that a product feature or ingredient is desirable—particularly when such phenomena are induced to a greater degree than an embodiment of the product which lacks the feature/ingredient or includes it in a different amount or degree. However, in situations in which a consumer does not itself purchase the product, a product designer's focus should be on inducing in purchasers either or both of i) the perception that the consumer enjoys the product and ii) enjoyment by the purchaser of the consumer's interaction with the product. Thus, even if non-verbalizing consumers enjoy a first of two embodiments more than the second, sales of the second embodiment can be expected to be stronger if purchasers either i) perceive that the consumers enjoy the second embodiment more than the first or ii) enjoy the consumers' interactions with the second embodiment more than they enjoy the consumers' interactions with the first (regardless of the consumers' preference). For these reasons, the enjoyment induced in consumers and the enjoyment induced in purchasers by a product are separate and not-necessarily-correlated measures of product desirability.

In addition to physiological phenomena which indicate enjoyment, other phenomena can indicate that an individual is motivated to act (i.e., rather than remaining inactive). In the methods described herein, it is of particular interest to identify in non-verbalizing consumers behaviors (or combinations of behaviors) which elicit, in observing humans, both perception that the consumers enjoy a product and motivation for humans to act upon such perceptions. Such behavior(s) can be expected to increase the likelihood that a parent of a non-verbalizing consumer of the same species will be motivated to purchase a product which induces the behavior(s). Thus, for example, product features or ingredients which induce cat behaviors that are perceived by cat parents both as indicative of pleasure experienced by cats and as motivational can be expected to induce cat parents to purchase the product (or more of it) when those cat parents witness such behavior, either in their own cats or in cats which are perceived in recorded materials.

For each of these phenomena, the magnitude or extent of the phenomenon can vary roughly in proportion to the magnitude of enjoyment or non-enjoyment. Also, some of the phenomena are exhibited during enjoyment, but not during non-enjoyment, and others are exhibited during non-enjoyment, but not during enjoyment. These phenomena, and their relationships with (non-)enjoyment, are well known and are not among the subject matter that the applicants purport to have invented. Each is described in the literature preceding this disclosure. Similarly, variations in degree and type of these phenomena among various species are well known, and a skilled artisan can adapt the methods described herein for substantially any known species.

While not a complete catalog of previously known studies which correlate enjoyment with physiological responses, the following references describe such correlations, and substantially any of those correlations can be used to link observed behaviors in the human observers described herein with positive or negative emotional responses in such observers:

1) References which describe correlations between positive or negative emotional responses in observers and facial expressions include at least Wolf et al., 2005, Scandinavian journal of psychology, 46 (5), 403-409; Adelmann et al., 1989, Annual review of Psychology, 40 (1), 249-280; Whalen et al., 1998, The Journal of neuroscience, 18 (1), 411-418; Ekman, 1999, “Facial Expressions.” Handbook of cognition and emotion, 16, 301-320; Wiss, 2012, “Identifying facial expressions associated with positive emotional states in dogs;” Laparra-Hernández et al., 2009, International Journal of Industrial Ergonomics, 39 (2), 326-332; Durso et al., 2012, Human Factors: The Journal of the Human Factors and Ergonomics Society, 54 (1), 60-69; Zhou et al., 2013, “Eliciting, Measuring and Predicting Affect via Physiological Measures for Emotional Design,” In Emotional Engineering vol. 2, pp. 41-62, Springer London; Ganchrow et al., 1983, Infant Behavior and Development, 6 (4), 473-484; Burgdorf et al., 2006). The neurobiology of positive emotions. Neuroscience & Biobehavioral Reviews, 30 (2), 173-187; Steiner et al., 2001, Neuroscience & Biobehavioral Reviews, 25 (1), 53-74; Soussignan et al., 1997, Physiology & Behavior, 62 (4), 745-758; Soussignan et al., 1995, Chemical senses, 20 (1), 47-59; Epstein et al., 1997, Appetite, 29 (2), 213-224; Zeinstra et al., 2009, Food Quality and Preference, 20 (8), 620-624; Steiner et al., 1995, Human evolution, 10 (2), 97-105; Steiner, 1994, “Behavior manifestations indicative of hedonics and intensity in chemosensory experience,” In Olfaction and Taste XI, pp. 284-287, Springer Japan.

2) References which describe correlations between positive or negative emotional responses in observers and EEG responses include at least Ariely et al., 2010, Nature Reviews Neuroscience, 11 (4), 284-292; Fugate, 2007, Journal of Consumer Marketing, 24 (7), 385-394; Schneider et al., 2009, Physiology & behavior, 98 (4), 447-452; Khushaba et al., 2013, Expert Systems with Applications, 40 (9), 3803-3812; Vakratsas et al., 1999, The Journal of Marketing, 26-43; Khushaba et al., 2012, Expert Systems with Applications, 39 (16), 12378-12388; Berg et al., 2007, U.S. patent application Ser. No. 11/851,638; Shimokawa et al., 2008, Neuroreport, 19 (16), 1557-1561; Madan, 2010, Eureka, 1 (1), 34-42; Hubert et al., 2008, Journal of Consumer Behaviour, 7 (4-5), 272-292; Aurup, 2011, “User preference extraction from bio-signals: An experimental study,” Doctoral dissertation, Concordia University; Vecchiato et al., 2011, Computational intelligence and neuroscience, 2011, 3; Khushaba et al., 2012, “A neuroscientific approach to choice modeling: Electroencephalogram (EEG) and user preferences,” In Neural Networks (IJCNN), The 2012 International Joint Conference on, pp. 1-8, IEEE; Gurumoorthy et al., 2011). U.S. patent application Ser. No. 13/104,821; Nakamura et al., 2009, September, “A Method for Evaluating the Degree of Human's Preference Based on EEG Analysis,” In Intelligent Information Hiding and Multimedia Signal Processing, 2009, IIH-MSP'09, Fifth International Conference on, pp. 732-735, IEEE; Motte, 2009, “Using brain imaging to measure emotional response to product appearance,” In 4th International Conference on Designing Pleasurable Products and Interfaces-DPPI 2009, pp. 187-198, Université de Technologic de Compiègne (UTC); Vecchiato et al., 2011, “Enhance of theta EEG spectral activity related to the memorization of commercial advertisings in Chinese and Italian subjects,” In Biomedical Engineering and Informatics (BMEI), 2011 4th International Conference on, Vol. 3, pp. 1491-1494, IEEE; Nagamachi, 1999 “Kansei engineering: the implication and applications to product development,” In Systems, Man, and Cybernetics, 1999, IEEE SMC'99 Conference Proceedings, 1999 IEEE International Conference on, Vol. 6, pp. 273-278, IEEE; Aurup et al., 2012, Journal of Integrated Design and Process Science, 16 (4), 3-18; Yilmaz et al, 2014, Computer methods and programs in biomedicine, 113 (2), 705-713; Lucchiari et al., 2012, Swiss Journal of Psychology, 71 (4), 199-204; Sylcott et al., 2011, “Understanding of emotions and reasoning during consumer tradeoff between function and aesthetics in product design,” In ASME 2011 International Design Engineering Technical Conferences and Computers and Information in Engineering. Conference, pp. 165-176, American Society of Mechanical Engineers; Harmon-Jones et al., 2010, Biological psychology, 84 (3), 451-462; Siniscalchi et al., 2013, Current Biology, 23 (22), 2279-2282; Larsen et al., 2008, Handbook of emotions, 3, 180-195; Liu et al., 2010, “Real-time EEG-based human emotion recognition and visualization,” In Cyberworlds (CW), 2010 International Conference on, pp. 262-269, IEEE; Charles et al., 1956, Electroencephalography and clinical neurophysiology, 8 (4), 645-652; Petersen et al., 1964, Electroencephalography and clinical neurophysiology, 17 (5), 557-563; MEIER et al., 1960, Psychological Reports, 6 (2), 307-314; Valatx et al., 1964, Electroencephalography and clinical neurophysiology, 17 (3), 218-233.

3) References which describe correlations between positive or negative emotional responses in observers and mirror neuron activity include at least Rizzolatti et al., 2004, Annu. Rev. Neurosci., 27, 169-192; Keysers et al., 2009, Current opinion in neurobiology, 19 (6), 666-671; Rizzolatti et al., 2004, Annu. Rev. Neurosci., 27, 169-192; Gallese et al., 2007, Journal of the American Psychoanalytic Association, 55 (1), 131-175.

4) References which describe correlations between positive or negative emotional responses in observers and lateral responses include at least Mazzotti et al., 2009, Laterality, 14 (2), 196-204; Holton et al., 1998, Journal of small animal practice, 39 (10), 469-474.

5) References which describe correlations between positive or negative emotional responses in observers and heart rate include at least Lane et al., 2009, Neuroimage, 44 (1), 213-222; Appelhans et al., 2006, Review of general psychology, 10 (3), 229; Hsu (date unknow), “Using Pupillary Response for Evaluating Users' Emotion Elicited by Cars;” von Borell et al., 2007, Physiology & Behavior, 92 (3), 293-316; Lane et al., 2009, Neuroimage, 44 (1), 213-222; Beerda et al., 1998, Applied Animal Behaviour Science, 58 (3), 365-381.

6) References which describe correlations between positive or negative emotional responses in observers and hormone/neurotransmitter levels include at least Buchanan et al., 1999, Psychoneuroendocrinology, 24 (2), 227-241; Takai et al., 2004, Archives of Oral Biology, 49 (12), 963-968; Hennessy et al., 1998, Applied Animal Behaviour Science, 61 (1), 63-77; Beerda et al., 1996, Hormones and behavior, 30 (3), 272-279; Beerda et al., 1998, Applied Animal Behaviour Science, 58 (3), 365-381; Turner et al., 2002, Stress: The International Journal on the Biology of Stress, 5 (4), 269-276; Kringelbach et al., 2009, Trends in cognitive sciences, 13 (11), 479-487; Smith, 1973, Progress in physiological psychology, 5, 299-351.

7) References which describe correlations between positive or negative emotional responses in observers and eye dilation include at least Ho et al., 2014, International Journal of Industrial Ergonomics, 44 (3), 436-441; Porges, 1997, Annals of the New York Academy of Sciences, 807 (1), 62-77; Krugman, 1964, Journal of Marketing Research, 15-19; Partala et al., 2003, International journal of human-computer studies, 59 (1), 185-198; Leknes et al., 2012, Social cognitive and affective neuroscience, nss062; Bradley et al., 2008, Psychophysiology, 45 (4), 602-607; Janisse, 1973, Canadian Psychologist/Psychologie canadienne, 14 (4), 311; Holton et al., 1998, Journal of small animal practice, 39 (10), 469-474; Heistad et al., 1977, Circulation research, 41 (3), 342-350; Koss, 1986, Journal of pharmacological methods, 15 (1), 1-19; Ogburn et al., 1998, Applied Animal Behaviour Science, 61 (2), 133-142; Heistad et al., 1978, Am J Physiol, 235 (5), H544-H552; Wilson, 1952, AMA Archives of Neurology & Psychiatry, 68 (3), 393-397.

Although it may be possible to consciously influence these phenomena (i.e., they are not strictly involuntary responses), the phenomena are generally spontaneously exhibited in response to enjoyment or non-enjoyment, unless conscious effort is made to suppress the phenomena. Exhibition of these spontaneous phenomena can thus be considered, generally speaking, relatively objective indicia of enjoyment or non-enjoyment by an individual.

### Assessing Consumer Enjoyment

The methods described herein may be applied to assess physiological characteristics of an animal subject as the animal interacts with a product or product embodiment. Characteristics indicate that an animal enjoys a product are useful for comparing various embodiments of a product, with a view toward selecting a ‘most-enjoyed’ or ‘most-enjoyed-for-the-cost’ embodiment of the product, for example. Characteristics indicative of consumer enjoyment of a product are also useful content to include in materials intended for the depictions of the product—at least to the extent that those ‘enjoyment’ characteristics are perceived as such by parents of such consumers. Parents, naturally, seek to obtain for non-verbalizing consumers in their care, products which the parents believe that those consumers will enjoy.

Assessment of objective physiological criteria of product enjoyment by a consumer can thus inform product design and development efforts. Product features or ingredients which enhance consumer enjoyment can be incorporated into the product, and behaviors or criteria indicative of consumer enjoyment can be included in materials shown to parents considering whether or not to purchase the product.

Methods and apparatus for directly assessing consumer enjoyment are generally applicable to most or all animals which are commonly owned or cared for by humans, including human infants, cats, dogs, rodents, and farm animals. Skilled artisans in this field are able to adapt known methods and apparatus to individual animals of various species without extensive or complicated experimentation.

Previously, product designers and developers have been guided by ordinary observation of interactions between non-verbalizing consumers and a product being designed. For example, designers and developers routinely observe the behaviors of animals interacting with a product during its design and make product design choices intended to yield animal behaviors that are subjectively considered to better appeal to animal parents or to indicate greater enjoyment of the product by the animal. However, those methods are limited by the subjectivity of the observations.

In one embodiment of the subject matter disclosed herein, objective physiological criteria of animals interacting with a product or a product prototype are measured in order to perform a less subjective indication of the animals' enjoyment of the product. Substantially any physiological assessment that has been or may hereafter be associated with a state of enjoyment in animals of the same species can be used. A non-limiting list of such assessments includes EEG responses, EMG responses, facial movements, heart rate variation, skin conductance, fMRI images, EKG responses, heart rate, heart rate variability, ear temperature differences, ear temperature changes, pupil dilation, saliva hormone and/or neurotransmitter levels (e.g., in blood or saliva). Preferably, such objective measures of animal/consumer enjoyment are assessed in combination with assessment of spontaneous emotional responses of parents of such animals (i.e., the actual parents of the animals observed, or parents of animals of the same species).

### Assessing Purchaser Enjoyment

An important goal of product designers and developers is to induce individual humans to purchase the product. For products which are consumed by the purchaser, designers and developers can focus their efforts on improving the purchaser's enjoyment of the product. Similarly, for products which are consumed by individuals able to verbally communicate their opinions to the purchaser, designers and developers can focus on improving the enjoyment of the purchaser and other consumers. Language thus permits a purchaser to accurately assess consumer enjoyment of a product, even if the purchaser does not himself consume the product. However, if a consumer cannot verbally communicate its opinions or reactions to a product to a purchaser, the purchasing decision may be divorced from a consumer's enjoyment of the product.

For products intended for consumption by an animal that cannot communicate through human verbal language with a purchaser, the purchaser must rely on his perception of the product including (but usually not limited to) the purchaser's perception of the degree to which the consumer enjoys (or will enjoy) the product. In view of the often-accurate ability of parents of infants and parents of pets (e.g., dog and cat owners) to assess the degree to which the infant or pet in their care enjoys a product, reliance on purchaser perception of consumer enjoyment can often be a close surrogate of direct reliance on consumer enjoyment. However, other emotional responses of the purchaser can factor into the purchase decision.

Potentially influencing the purchase decision is the degree to which (independent of the consumer's enjoyment of the product) the purchaser enjoys the consumer's interaction with the product. For example, dogs may perceive no substantial difference between a generally cylindrical chew made of ground rawhide scraps and a similar chew shaped and colored to resemble a hot dog on a bun; the purchaser may nonetheless derive a significantly positive emotional response to watching the purchaser's dog chew on a “hot dog” rather than a cylinder of ground rawhide. A product designer or developer should take such emotional responses of the purchaser into account.

Also, potentially influencing the purchase decision are misperceptions by the purchaser of a non-verbalizing consumer's actual or perceived enjoyment of the product. Such misperceptions relate to incoherence between the consumer's emotional response to a product and what the purchaser perceives to be the consumer's emotional response to the product (or the response of an animal of the same species to the product, for example in an advertisement or while witnessing another animal interact with the product). By way of example, excessing licking of a cat's “lips” (the fur and skin surrounding the cat's mouth) is frequently perceived by cat parents as a positive emotional response (i.e., like a person licking his lips, the cat is perceived to consider a product tasty or satisfying). However, excessive lip-licking by a cat can be a sign of a negative emotional response to a product that is perceived by the cat to be excessively sticky, messy, or greasy. This is an example of a divergence between the true emotional response of a non-verbalizing consumer and a purchaser who is unable to communicate with that consumer. When designing and developing products for such purchaser-consumer pairs, product designers and developers can use the methods described herein to differentiate the respective preferences of the consumer and purchaser to, for example, i) design and develop a product that will appeal to purchasers, irrespective of the consumer's preference or ii) design a product that will best appeal to the consumer's preferences and communicate the divergence between consumer and producer perceptions through informational materials associated with the product (e.g., advertisements which inform purchasers about the divergence).

There may be other reasons, not explicitly identified in this disclosure, why purchaser perceptions of a product diverge from a non-verbalizing consumer's perception of the same product. Regardless of the reason underlying such divergence, the methods described herein can be used by a product designer or developer to detect such divergence and to make design and development choices in view of that information. Identification of distinct perceptions of purchasers and consumers does not force a designer or developer to choose one or the other set of perceptions, but instead permits designers and developers to make product design and development choices in response to one or the other set or to both.

A shortcoming in methods used by others to assess human perceptions of non-verbalizing consumer emotional responses to a product or product embodiment relates to human psychology. For a wide variety of psychological reasons, the reports made to researchers by human who observe non-verbalizing consumers interacting with products or embodiments thereof, can diverge from the actual perceptions of those human observers. For example, perceptions by the observers that researchers do or do not wish to hear certain reports or subjective beliefs by observers that certain responses would cause them to seem foolish or unintelligent can lead observers to report observations which differ from their true opinions. Numerous other factors can influence subjective human reports, and no attempt is made in this disclosure to fully catalog such factors. It is sufficient to conclude that subjective human reports that are consciously made to researchers can differ substantially from the true perceptions of the human observers.

An important aspect of the methods described herein is their employment of substantially objective physiological responses recorded for human observers. The physiological responses described herein are less susceptible to the factors which can influence subjective verbal responses of human observers, and can therefore provide valuable information useful for designing and development of products intended for consumption by animals of the type observed by the human observers.

The methods described herein involve assessment of physiological phenomena which are often not consciously influenced by subjects, at least unless the subjects are aware that the phenomena are being observed. It can therefore be advantageous to refrain from identifying to human subjects the nature of the phenomena that are being observed, or to deemphasize the significance of those observations. Instrumentation or equipment (e.g., skin-mounted electrodes) necessary for assessment of some of the physiological responses usable in the methods described herein can be difficult or impossible to hide from human observers. In such instances, researchers can refrain from drawing particular attention to the instruments or equipment, can be vague in descriptions of the purpose of the instruments or equipment, or can particularly emphasize other observer responses that are being collected (e.g., verbal subjective reports) regardless of the actual significance of those other responses to the study. Instrumentation or equipment which can be obscured from the human observers' perception (e.g., a camera disposed in a non-apparent location, obscured behind a screen, or disguised as another object) can lessen the risk that conscious interaction by the observers will skew the physiological responses that are assessed in the methods described herein.

### Performance of the Methods

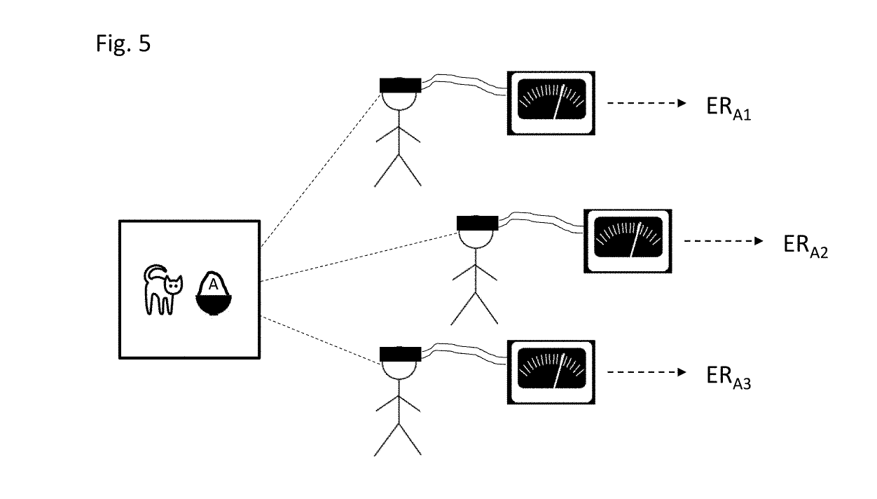

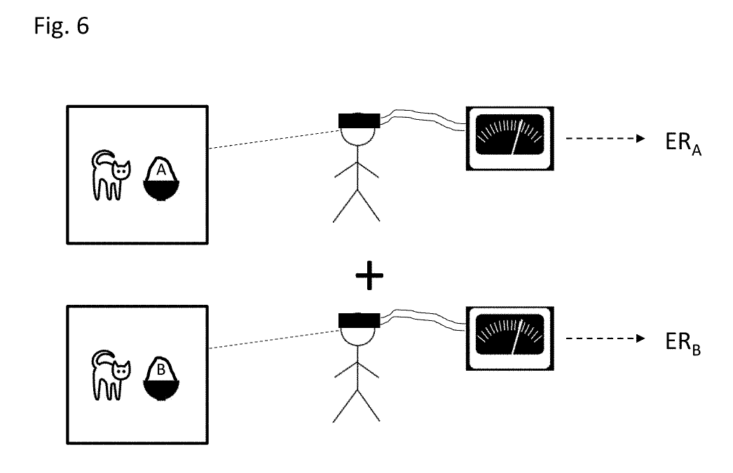

The methods described herein can be used to assess physiological responses of one or more humans who observe one or more non-verbalizing consumers interacting with a product or a product embodiment (see FIGS. 3-6). By way of example, a human (or a panel of humans, separately and individually assessed) can observe video recordings of pet animals (e.g., domestic cats) who are interacting with a product (or one or more embodiments of a product). The physiological responses of individual humans can be recorded for each of a defined collection of such videos and the responses of the individual humans either considered in the aggregate or considered separately for each video. The observations made of the physiological responses of the human observers can be assessed to gauge the emotional responses of the human observers—again, either individually or collectively (e.g., by averaging responses or by considering a scatter plot or other representation of individual responses). The knowledge gained by assessing the emotional responses of the human observers can be used by designers and developers of a product to make products and informational materials which are more appealing to humans (i.e., which are more likely to induce humans to purchase the product for non-verbalizing consumers of the same species as that observed and/or to better inform human purchasers about the significance of consumers' reactions to the product).

In general, the methods are performed as follows. Spontaneous emotional responses exhibited by each of a plurality of human observers are separately assessed as each observer observes provision a product to at least one non-verbalizing consumer (e.g., each observer views and hears a video and sound recording of a dog interacting with a chew toy). The responses of the observers can be compared, for a number of purposes. For example, responses of human observers (either individual or collective) to provision different embodiments of a single product can be compared to determine one or more of i) which embodiment the observers believe the consumers most enjoyed (“preference of the consumer”); ii) for which embodiment the observers most enjoyed observing interaction of the consumer and the embodiment (“preference of the observer”); and iii) which embodiment the observers felt most likely to purchase for a consumer of the same species (“purchase preference”).

The particular designations given to comparisons of human physiological phenomena is immaterial, as is the precise nature of the comparison. What is significant is that comparisons can be made among relatively objective characteristics exhibited by human observers, so that product features/ingredients and consumer behaviors which appeal to humans can be discerned. These observations of relatively objective criteria can be combined with subjective reports of the same or other human observers, with relatively objective ‘enjoyment’ data obtained by observation of physiological phenomena of the consumers, with both, or with neither. This information can guide product design and development efforts.

The particular spontaneous emotional responses that are recorded from human observers (and from the animal consumers, if desired) are not critical, and can include any of the physiological characteristics described herein. By way of example, at least one of EEG responses, EMG responses, facial movements, heart rate variation, skin conductance, fMRI images, EKG responses, heart rate, heart rate variability, ear temperature differences, ear temperature changes, pupil dilation, saliva hormone and/or neurotransmitter levels (e.g., in blood or saliva) can be assessed. Preferably, multiple ones of these criteria (e.g., two or more, three or more, etc.) are assessed for each human observer. Similarly, the particular method by which or equipment or instrumentation with which these phenomena are assessed are not critical; any method or equipment known or hereafter developed can be used.

The identity of the human observers is not critical, other than that the observers ought to be generally familiar with animals of the species that are being observed and their behavior. The observers preferably are a parent (as the term is used herein) at least one animal of the species being observed. For example, observers of human infants are preferably current or past parents of a human infant, observers of cats are preferably current or past owners of or care-providers for at least one cat, and observers of horses are preferably owners of or care-providers for at least one horse. It can also be beneficial if the human observers have approximately the same relation with the observed animals as purchasers of the product have with the animals.

The observations made by the human observers can be of recordings (video and/or sound) of consumers interacting with the product, live interactions of consumers with the product, or a combination of the two. Where recordings are used, the recordings can be viewed at or near the time when and place where the recordings are made, or the recordings can be viewed by observers at times (e.g., days, months, or years after recording) and places (e.g., in studios or on computer monitors connected to the recording or storage site via the Internet) significantly different than the time when and place where the recordings are made,

The nature of the interaction of the consumer with the product that is observed by the humans is not critical, but is preferably the same type of interaction which the consumer will normally be expected to have with the product. By way of example, if the product is a cat treat, the observed interaction preferably includes one or more of signaling that the treat is about to be provided; bringing a container containing treat into the view of the consumer; removing the treat from the container in the view of the consumer; offering the treat to the consumer; reception of the treat by the consumer; chewing, playing, or other manipulation of the treat by the consumer; interaction of the consumer with a human providing the treat; and interaction of the consumer with the human after the treat has been provided.

Once the physiological responses of human observers have been collected for a product (or for multiple product embodiments), the responses can be compared to assess the desirability of including alternative ingredients/features in the product, the desirability of including depictions of certain consumer behaviors (typically those inducing the greatest emotional response in human observers, those inducing the greatest motivation to purchase the product, or similar observations) in informational materials pertaining to the product (e.g., package labels, magazine or Internet articles, or even advertisements).

### EXAMPLES

The subject matter of this disclosure is now described with reference to the following Examples. These Examples are provided for the purpose of illustration only, and the subject matter is not limited to these Examples, but rather encompasses all variations which are evident as a result of the teaching provided herein.

### Example 1

The experiments described in this example were performed to better understand specific cat behaviors that cat owners use to judge cat enjoyment of a meal or treat. A primary objective was to gain a deeper understanding of cat behaviors which cat owners use to judge whether their cat “likes” or “dislikes” a meal/treat

An important function of pet food (e.g., food and treats) products is to build positive emotional associations between the pet parent and the product. In the study described in this example, we identified several cat behaviors which evoke positive experiences in cat parents viewing cat behaviors. Another important function of a pet food product is to motivate the parent to desire the product. We identified several cat behaviors that evoke desire in cat parents viewing these behaviors. Finally, pet food products should inspire parents to want to take some action toward the product. We identified several cat behaviors that cause brain activity related to action preparation or evoke empathy with the behavior.

The identities of the particular cat behaviors which evoked positive emotion, motivation, and action in parents viewing those behaviors are not critical and are not described here.

Described below are the methods used to determine those associations. Because such cat behaviors evoked consistent responses in parents across all three areas of assessment (e.g., emotion, motivation, and action), connecting such behaviors with a product would likely enhance parents' perceived enjoyment of these products. These methods were performed as follows.

In summary, we developed videos of cat behaviors, recruited 81 cat parents meeting study criteria, and measured neurological and psychological processes of each study participant as the participant watched the videos of cat behaviors. By analyzing the data thus obtained, cat behaviors which evoked positive emotion, motivation, and action in the study participants could be identified.

Measurements that were made, and their components are listed below in Table 1.

TABLE 1
Measurements.

| Aggregated Measure | Description | Component Measures |
|---|---|---|
| Facial Expression | Indication of positive | Facial Electromyography |
| (Positive vs. | or negative emotion | (EMG), Video Coding |
| Negative) | | |
| Neurophysiological | Indication of desires | Frontal Brain Asymmetry |
| Motivation | | (EEG), Heart Rate |
| Action Preparation | Indication of action | Motor Cortex Activity |
| (Movement | tendencies | (EEG), Minor Neuron |
| Tendency) | | Activity (EEG) |
| Subjective Choice | Indication of conscious | Self-reported favorite and |
| (Favorite vs. | preferences | least favorite behaviors |
| Least Favorite) | | |

Examples of cat behaviors which were recorded and shown to study participants when assessing wet or dry cat foods are listed in Table 2.

TABLE 2
Examples of Cat Behaviors- Wet/Dry Foods

| Wet/Dry Food - Behavior Name | Behavior Description |
|---|---|
| Circles Bowl | Cat circles around bowl in feeding area |
| Face in Can | Cat tried to put its face in can |
| Feed Me (Sits Pretty) | Cat sits in feed area begging for food |
| Interested in Food | Cat appears interested in food |
| (Interested in Can) | |
| Knead (Kneading/Kneads | Cat kneads paws in anticipation |
| Paws/Kneading One Paw) | |
| Lead (Leading Walk/Leads | Cat leads parent to feeding area |
| to Dish/Walks to Dish/ | |
| Walking to Dish) | |
| Look (Interested Look/Eager | Cat looks longingly |
| Look/Longing Look) | |
| Ready | Cat has tail raised, alert ears, wide |
| | eyes, fanned whiskers |
| Rub (Rubs Leg/Rubbing Leg) | Cat rubs up against parents legs |
| Rub Can (Rubbing Can/Rub | Cat rubs food can or container |
| Container) | |
| Standing (Standing Begging) | Cat sits up in feeding area begging |
| | for food |
| Tap (Raises One Paw) | Cat raises one paw up begging |
| Underfoot (Circles/Circling | Cat circles parents leg |
| Leg/Circling underfoot) | |
| Disgust (Looks Disgusted) - | Cat looks up to parent in disgust |
| Post Feeding | |
| Sniffs Food - Post Feeding | Cat sniffs food |
| Stops Eating - Post Feeding | Cat will not continue eating food |
| Walks Away - Post Feeding | Cat leaves eating area, upset |
| Will Not Eat - Post Feeding | Cat refuses to eat food |

Examples of cat behaviors which were recorded and shown to study participants when assessing cat treats are listed in Table 3.

TABLE 3
Examples of Cat Behaviors - Treats

| Treats - Behavior Name | Behavior Description |
|---|---|
| Butt in Face | Cat turns around on bed putting |
| | its rear end in parents face |
| Face in Can | Cat tried to put its face in can |
| Kiss (Kisses Face/Kiss | Cat puts face up to cat parents face |
| on Face/Face to Face) | |
| Follow Hand (Following Hand) | Cat follows hand for treat |
| Hugs (Snuggles) | Cat embraces parent |
| Kneading (Knead/Kneads | Cat kneads paws in anticipation |
| Paws/Kneading Paws) | |
| Lead (Leading Walk/Leads to | Cat leads parent to feeding area |
| Dish/Walks to Dish/Walking | |
| to Dish) | |
| Lick (Licking) | Cat licks parent |
| Look (Interested Look/Eager | Cat looks longingly |
| Look/Longing Look) | |
| Ready | Cat has tail raised, alert ears, |
| | wide eyes, fanned whiskers |
| Rub (Rub Leg/Rubbing Leg) | Cat rubs up against parents legs |
| Rub Can (Rubbing Can/Rub | Cat rubs food can or container |
| Container) | |
| Rub Chest | Cat bumps against parents chest |
| Rub Hand | Cat rubs against parents hand |
| Rub Side | Cat rubs against parents side |
| Samples Treat | Cat takes one or two bites of treat |
| Sniffs Can | Cat sniffs can before trying food |
| Solicit Pet (Solicits Petting) | Cat rubs parent looking for petting |
| Tap (Raises One Paw) | Cat raises one paw up begging |
| Disgust (Disgusted Look/Looks | Cat looks up to parent in disgust |
| Disgusted) - Post Feeding | |
| Sniffs - Post Feeding | Cat sniffs food |
| Walks Away - Post Feeding | Cat leaves eating area, upset |

Table 4 is a list of the names and descriptions of measures used to investigate parent perceptions of cat behaviors. Aggregate Measures listed above in Table 1 are composed of like measures (e.g., measures assessing motivation).

TABLE 4
Measures

| Measure | Description |
|---|---|
| “Furrowed Brow” | Indication of negative emotion (EMG) |
| (Corrugator Supercilii) | |
| “Smile Activity” | Indication of positive emotion (EMG) |
| (Zygomaticus Major) | |
| Video Monitoring | Visible facial expressions |
| Heart Rate | Physiological excitement (EKG) |
| Approach Motivation | Relates to positive affect and approach |
| (Frontal Brain Asymmetry) | motivation |
| Action Preparation | Related to approach motivated movement |
| Minor Neuron Activity | Active when observing the movement of |
| | others |
| Behavioral Responses | Self-reported favorite and least favorite |
| | behaviors as well as the impact the product |
| | had on the relationship between the cat and |
| | the cat parent |

Study participants were screened to select cat parents having the following characteristics: 1-3 cats in the home (at least one cat older than 1 year); pet parent between the ages of 25 and 65; household income above $25,000; pet parent responsible for buying food/feeding cat(s); frequency of pet food purchasing greater than once a month; employment outside of the pet care industry; 20/20 or corrected to 20/20 vision; and right hand dominance.

Participants were invited into the lab for a two-hour visit. Care was made by the experimenters to ensure that each participant was comfortable with their surroundings before the procedure began. Experimenters adopted a friendly and professional demeanor during all interactions with the participants. Parents were told the purpose of the study was to investigate psychophysiological activity in response to cat behavior videos. Each parent watched nine videos of cat behavior while their responses were assessed by EEG, EMG, electrocardiogram (EKG), and video recording.

The physiological components of the procedure (including EEG, EMG, EKG, and video recording) were consistent with both psychophysiological science field standards used in past studies in the field. EEG was collected using 64 tin electrodes mounted in a stretch lycra cap (Electro-Caps, Eaton, Ohio) placed using the 10-20 system based on anatomical markers. A ground electrode was mounted between FPZ & FZ sites and a reference was placed on the left earlobe. All impedances were kept under 5 kilo ohm and were within 1 kilo ohm for all homologous pairs. Data were amplified using Neuroscan SynAmps RT amplifier unit (El Paso, Tex.). Signals were low-pass filtered at 100 Hertz, high-pass filtered at 0.05 Hertz, notched filtered at 60 Hertz, and digitized at 2,000 Hertz. Aberrant signals were removed by hand and a regression based algorithm was used to remove eye movements.

Two facial sites were chosen to record electromyography (EMG): zygomaticus major (cheek); corrugator supercilii (brow). Two 4 millimeter tin bipolar sensors were used at each site. Each sensor was placed according to the guidelines provided by The Society for Psychophysiological Research (Fridlund & Cacioppo, 1986). Facial EMG provides information about subliminal affect and identifies activity that would be missed by human detection. These sites were chosen because research has shown that the corrugator supercilii relates to negative affect while the zygomaticus major relates to positive affect. Impedances were kept below 5 kilo ohm for all sensors, low-pass filtered at 500 Hertz, high-pass filtered at 0.05 Hertz, and notch filtered at 60 Hertz (Hess, 2009).

The apparatus described herein can be used to effect segregation of cells in a blood sample among multiple physical areas of the apparatus (e.g., at, above, or on the upstream side of selected steps in a separation element). The layout of the apparatus and selection of its operating conditions can reproducibly result in disposition at identifiable locations of certain cells, such that operation of the device with a blood sample and observation of cells disposed at those locations is indicative of a physiological condition in the subject from whom the sample was taken.

A four minute resting file was acquired for each participant following the set-up procedure. The resting period is designed to record baseline neural activity. However, it also has the added benefit of providing the parent with additional time to acclimate to the equipment before beginning the study. Based on universal resting procedures, two minutes of recording was done with eyes closed (C) and two minutes of recording was done with eyes open (O). Two sequences were used: C-O-O-C; O-C-C-O. Aberrant signals were removed from the resting data by hand and a regression based algorithm was used to remove eye movements.

Participants were recorded while they watched the cat behavior videos. In order to reduce parent discomfort during the study, the camera was disguised as a speaker. Two experimenters were trained to code the facial expressions demonstrated by the participants during the experiment. Each expression (smiling, laughing, furrowing brow—disgusted, furrowing brow—interested, pursing lips, yawning, falling asleep, looking around, general movement, frowning) was recorded according to intensity level: 0—not present, 1—barely present, 2—present.

Each participants viewed each video (e.g., Dry Food videos, Wet Food videos, Treat videos). However, each participant saw the videos in a different order. For example, one participant might have viewed the Wet Food videos first, then the Treat videos, and finally the Dry Food video. Each participant was exposed to one of nine conditions (chosen at random), which determined the order in which the participant viewed the cat behaviors. Each participant viewed one positive dry food video, two negative dry food videos, one positive wet food video, two negative wet food videos, one positive treat video, and two negative treat videos. After viewing each video in its entirety, participants were asked to rate how they felt the food served impacted the relationship between the cat and the owner. Then, for each video segment participants were asked to identify their favorite and least favorite behaviors and to rate those behaviors on enjoyment.

Processing procedures were based on convention (i.e., published industry standards). Signals from the EMG sensors were processed and analyzed to identify positive/negative affective reactions, motivational tendencies, and arousal cat behaviors. Specifically, activity in the sensors placed on the zygomaticus major muscle structure (smiling activity) was captured to identify positive affect. Sensors placed on the corrugator supercilii muscle structure (furrowed brow activity) was captured to identify negative affect. EEG activity was analyzed focusing on alpha, beta, and mu frequencies. Data were analyzed to identify asymmetrical activity occurring in the frontal lobe area of the brain in order to analyze approach motivation. EEG beta and mu activity was also assessed in the motor strip area of the brain to investigate motor cortex activity and minor neuron activity. Arousal levels in response to the cat behaviors were assessed using data collected from the EKG sensors placed on each of the participant's arms. Finally, the video recordings of the participants were used to identify affective facial muscle movements in response to cat behavior.

### Measures

### Smile Activity

A one way ANOVA tested the effect of behavior type on zygomaticus major (smile) activity. Results revealed a moderately significant effect, both in participants observing wet/dry food feeding, F(10, 580)=1.63, p=0.094, ηₚ²=0.027 and in participants observing treat feeding, F(16, 816)=7.02, p<0.001, ηₚ²=0.121.

These results indicate that zygomaticus major activity can be correlated with positive emotion, both in study participants observing cat wet/dry food feeding behaviors and in study participants observing cat treat feeding behaviors.

### Furrowed Brow

A one way ANOVA tested the effect of behavior type on corrugator supercilii (furrowed brow) activity. Results revealed a significant effect, both in participants observing wet/dry food feeding, F(10, 640)=10.00, p<0.001, ηₚ²=0.135 and in participants observing treat feeding, F(16, 976)=3.29, p<0.001, ηₚ²=0.051.

These results indicate that corrugator supercilii activity can be correlated with negative emotion, both in study participants observing cat wet/dry food feeding behaviors and in study participants observing cat treat feeding behaviors.

### Visible Facial Expression

Coding of visible facial expressions did not reveal differences between behaviors (all p-values>0.05) in participants observing wet/dry food feeding. Because one aspect of facial expressions is to communicate emotions, parents may have reduced visible facial expressions owing to the fact that they viewed videos alone. Although they may have been less likely to display overt facial expressions, non-visible facial expressions still occurred, as measured by neurophysiological measures on the face (e.g., smiling activity and furrowed brow).

### Heart Rate

A one way ANOVA tested the effect of behavior type on heart rate. Results revealed no significant effect, either in participants observing wet/dry food feeding, F(10, 590)=0.67, p=0.774, ηₚ²=0.011, or in participants observing treat feeding F(16, 912)=1.17, p=0.288, ηₚ²=0.020.

### Approach Motivation

A one way ANOVA tested the effect of behavior type on left frontal cortical activity in participants observing wet/dry food feeding. Results revealed a significant effect, F(10, 690)=1.99, p=0.032, ηₚ²=0.028 on approach motivation (roughly speaking, the tendency of perception of a stimulus to cause the perceiver to desire to move toward the stimulus). These results indicate that left frontal cortical activity can be correlated with positive affect and approach motivation in study participants observing cat wet/dry food feeding behaviors.

A one way ANOVA tested the effect of behavior type on left frontal cortical activity. Results revealed no significant effect in participants observing treat feeding, F(16, 1008)=0.60, p=0.884, ηₚ²=0.009.

### Action Preparation

A one way ANOVA tested the effect of behavior type on beta suppression (action preparation). Results revealed a significant effect on action preparation (roughly speaking, the tendency of a stimulus to induce motor activity in a perceiver of the stimulus), both in participants observing wet/dry food feeding F(10, 690)=1.99, p=0.032, ηₚ²=0.028, and in participants observing treat feeding, F(10, 1008)=2.81, p<0.001, ηₚ²=0.043.

These results indicate that beta suppression can be correlated with positive indication of action tendencies, both in study participants observing cat wet/dry food feeding behaviors and in study participants observing cat treat feeding behaviors.

### Mirror Neuron Activity

A one way ANOVA tested the effect of behavior type on mu suppression (mirror neuron activity). Results revealed a significant effect, both in participants observing wet/dry food feeding, F(10, 690)=6.25, p<0.001, ηₚ²=0.083, and in participants observing treat feeding, F(10, 1008)=4.65, p<0.001, ηₚ²=0.069.

These results indicate that mu suppression can be correlated with positive indication of action tendencies, both in study participants observing cat wet/dry food feeding behaviors and in study participants observing cat treat feeding behaviors.

### Cat Behavior Choice: Choosing Favorite Behaviors

After seeing each video, cat parents self-reported their favorite feline behaviors and their least favorite feline behaviors. For each video, cat parents were given a range of 2-7 behaviors to choose from. Out of each 2-7 behaviors (e.g., Favorite 1, Favorite 2), parents indicated their favorite or least favorite behaviors. Chi-Square analyses of behavior frequency revealed that behavior choice frequency was significantly greater than chance.

From the physiological response and subjective choice data described above, it was possible to correlate particular cat behaviors with positive and negative responses and choices. These data indicate that similar testing (i.e., employing multiple product embodiments or multiple embodiments of recorded materials) can be used to assess the effects that product design and development choices will likely have upon cat parent emotional and motivational state. Such testing can thus help designers and developers of products to better perform their design and marketing tasks.

### Example 2

This example describes a procedure for assessing the emotional responses of dogs to anticipated provision of a food or treat.

fMRI allows an investigator to accurately determine brain activity and to link such activity with associated emotional responses. fMRI methods are humane and accurate. Participating dogs are situated with an fMRI scanner and remain motionless throughout the experimental period.

An investigator tests the anticipated gustatory reward value of two food or treat products. The experiment incorporates two hand signals which are taught to participating dogs, one that denotes impending provision of food/treat A and another signal that denotes impending provision of food/treat B. An investigator measures the responses to the hand signals in the caudate, an area of the brain with high dopamine concentrations that indicates emotional anticipatory pleasure responses, during the 20-second interval following exposure of the dog to one of the hand signals. The corresponding product is then provided to the dog.

The fMRI requirement for motionlessness prevents subsequent measure of gustatory responses or emotional responses while the dog is chewing or swallowing the product. However, an investigator can measure emotional responses immediately prior to the ingestion of the treat. Similarly, an investigator can measure gustatory and emotional responses immediately after the dog has ingested the treat and has returned to a static position within the chin rest.

After completing 30 trial repetitions (15 with each treat) with each dog subject, for example, an investigator can discern differences in caudate and olfactory activity between the alternative products. Higher caudate activity can be presumed to equate to greater anticipated (and actual) pleasure associated with a particular food/treat.

The disclosure of every patent, patent application, and publication cited herein is hereby incorporated herein by reference in its entirety.

While this subject matter has been disclosed with reference to specific embodiments, it is apparent that other embodiments and variations can be devised by others skilled in the art without departing from the true spirit and scope of the subject matter described herein. The appended claims include all such embodiments and equivalent variations.

What is claimed is:

1. A method of assessing purchaser preference for embodiments of a product intended for consumption by non-verbalizing consumers, the method comprising
separately assessing spontaneous emotional responses exhibited by each of a plurality of human observers as each observer observes provision of at least a first embodiment of a product and a second embodiment of a product to one or more animals of the same species as the non-verbalizing consumers, and
comparing i) the responses of the observers of provision of the first embodiment to the animals and ii) the responses of the observers of provision of the second embodiment to the animals in order to determine a preference of the observers as a surrogate for the preference of purchasers.

2. The method of claim 1, wherein the spontaneous emotional responses which are assessed include at least one of electroencephalography (EEG) responses, electromyography (EMG) responses, facial movements, heart rate variation, skin conductance, functional magnetic resonance imaging (fMRI), electroencephalography (EEG), monitoring of heart rate, monitoring of heart rate variability, monitoring of ear temperature differences, monitoring of ear temperature changes, monitoring of pupil dilation, monitoring of saliva hormone levels, monitoring of saliva neurotransmitter levels, monitoring of blood hormone levels, and monitoring of blood neurotransmitter levels.

3. The method of claim 1, wherein the physiological responses that are recorded include at least three of EEG responses, EMG responses, facial movements, heart rate variation, and skin conductance.

4. The method of claim 1, wherein the observers are selected to be parents of an individual of the same species as the non-verbalizing consumers.

5. The method of claim 1, wherein the responses of the observers to provision of the first and second embodiments are integrated and the integrated responses of the observers are compared to determine the preference of the observers.

6. The method of claim 1, wherein a subjective assessment of each animal's response to each embodiment is recorded for each observer.

7. The method of claim 1, wherein each observer is at least one of a parent and a former parent of an animal of the same species as the non-verbalizing consumers.

8. The method of claim 1, wherein the consumers are animals of a species kept as pets by humans.

9. The method of claim 8, wherein the consumers are cats.

10. The method of claim 8, wherein the consumers are dogs.

11. The method of claim 1, wherein the consumers are animals of a species kept as working animals by humans.

12. The method of claim 1, wherein the consumers are non-verbalizing humans.

13. The method of claim 12, wherein the non-verbalizing humans are infants.

14. The method of claim 12, wherein each of the observers has parented a child.

15. The method of claim 1, wherein at least one observer observes a recording of provision of at least one of the first and second embodiments to the animals.

16. The method of claim 1, wherein at least one observer observes video images of provision of the first and second embodiments to the animals.

17. The method of claim 1, wherein the animals are domestic cats and the cats exhibit behaviors that include at least one of the “rub,” “lead,” and “standing” behaviors described in example 1 hereof.

18. A method of developing a product for non-verbalizing consumers, the method comprising
producing first and second embodiments of the product,
providing the first and second embodiments to individual consumers,
recording spontaneous physiological responses in each of a plurality of human observers as each observer observes provision of the first and second embodiments of the products to the consumers,
comparing i) the responses of the observers of provision of the first embodiment to the consumers and ii) the responses of the observers of provision of the second embodiment to the consumers in order to determine which embodiment induces the more positive responses in the observers as a surrogate for the preference of the consumers, and
incorporating into the product the embodiment preferred by the observers.

19. A method of designing a product for non-verbalizing consumers, the method comprising
separately assessing spontaneous emotional responses exhibited by each of a plurality of human observers as each observer observes provision of at least a first embodiment of the product and a second embodiment of the product to at least one animal of the same species as the non-verbalizing consumers, and
comparing i) the responses of the observers to provision of the first embodiment and ii) the responses of the observers to provision of the second embodiment to the consumers in order to determine a preference of the observers, and
incorporating into the design of the product the embodiment preferred by the observers.

20. A method of assessing perceived preference of non-verbalizing consumers for features of a product, the method comprising
separately assessing spontaneous emotional responses exhibited by each of a plurality of human observers as each observer observes provision of at least a first embodiment of the product that incorporates a first feature and a second embodiment of the product that incorporates a second feature to at least one animal of the same species as the non-verbalizing consumers, and
comparing i) the responses of the observers to provision of the first embodiment and ii) the responses of the observers to provision of the second embodiment to the consumers in order to determine a preference of the observers as a surrogate for the preference of the consumers for the first and second features.
